(19) United States
(12) Patent Application Publication
(10) Pub. No.: US 2006/0063439 A1
(43) Pub. Date: Mar. 23, 2006

(54) All-terrain vehicle floats

(76) Inventor: Jean-Pierre Krucker, Garson (CA)

Correspondence Address: MIKE GAUTHIER;UNIT C, 959 ELISABELLA STREET, SUDBURY, ON, P3A 5K1, CA

(21) Appl. No.: 10/943,025

(22) Filed: Sep. 17, 2004

(51) Int. Cl. B63H 1/00; B60F 3/00; B63H 19/08

(52) U.S. Cl. 440/12.5

(57) ABSTRACT

A floatation device adapted to convert between a boat-like system and floats for an all-terrain vehicle (hereinafter referred to as ATV). Two pontoons are slidably attached to each other using tubular telescopic motion therebetween so as to allow widening the distance between said pontoons when so desired. Yet an extendable towing tongue is provided, having hitch attaching means there-attached wherein the tongue could be tucked within the pontoon frame when the floatation device is used as a boat-like system. A wheel attachment is adaptable to the cross members in order to pull the device as a trailer.

### FIELD OF THE INVENTION

The present invention relates to a floatation device adapted to convert between a boat-like system and floats for an all-terrain vehicle (hereinafter referred to as ATV). Two pontoons are slidably attached to each other using tubular telescopic motion therebetween so as to allow widening the distance between said pontoons when so desired. Yet an extendable towing tongue is provided, having hitch attaching means there-attached wherein the tongue could be tucked within the pontoon frame when the floatation device is used as a boat-like system. A wheel attachment is adaptable to the cross members in order to pull the device as a trailer.

### BACKGROUND OF THE INVENTION

More and more, ATVs are becoming a common part of the sportsman's outfit. These serve a variety of useful functions that will likely increase their popularity in the near future. However, ATVs are limited when faced with a large body of water; they simply do not float.

Prior art has introduced many versions of amphibious vehicle, some quite cleaver! Unfortunately, these amphibious vehicles are usually heavier, larger and inadaptable to tighter, smaller environments.

The applicant of the present invention sought to make available to those desiring the best of both vehicles, a floatation device adapted to be towed behind and ATV or the like. By doing so, the floatation device of the present invention can serve as a cargo trailer, a fishing pontoon boat floats—on, which an ATV may be adapted to attach thereto—. Furthermore, once a sportsman is at his/her destination, the ATV can be utilized as an ATV, not interdependent with the floatation device thereby allowing the desired freedom sought by such sportsmen.

While attempts have been made to provide sportsmen with ATV floats—which while being useful, is non-obtrusive, adaptable to virtually all ATVs, can serve as a pontoon boat, a cargo trailer, ATV floats, and can even help stabilize an ATV in soft terrain situations—none of the prior art combines all these benefits in one system.

### SUMMARY OF THE INVENTION

It is thus the object of the present invention to provide sportsmen with a combination; pontoon boat, cargo trailer, ATV floats, and an ATV stabilizer.

In one aspect of the invention, the molded resin pontoon design may be fabricated of any equally suitable material.

In another aspect of the invention, the attachment means of the floatation device to an ATV may vary from that depicted in the present disclosure.

Accordingly, the system of the present invention provides sportsmen with a combination; pontoon boat, cargo trailer, ATV floats, and an ATV stabilizer that is unobtrusive and provides the desired freedom of all feature uses.

### BRIEF DESCRIPTION OF THE DRAWINGS

These and other advantages of the invention will become apparent upon reading the following detailed description and upon referring to the drawings in which:

FIG. 1 is a perspective view from the front of the all-terrain vehicle floats of the present invention in the ATV float arrangement.

FIG. 2 is a perspective view from the rear of the all-terrain vehicle floats of the present invention in a trailer arrangement.

FIG. 3 is a side elevation view of the all-terrain vehicle floats of the present invention.

FIGS. 4 & 5 are both cross-sectional views taken from FIG. 3 of a pontoon of the present invention.

FIG. 6 is a partial right side elevation view of the all-terrain vehicle floats of the present invention as shown in a trailer arrangement.

FIG. 7 is a right side elevation view of the frame portion of the all-terrain vehicle floats of the present invention.

FIG. 8 is a top plan view of the all-terrain vehicle floats of the present invention in a trailer arrangement.

FIG. 9 is a top plan view of the all-terrain vehicle floats of the present invention in a float arrangement.

FIG. 10 is a side elevation view of the all-terrain vehicle floats of the present invention as adapted to an ATV in a float arrangement.

FIG. 11 is a front perspective view from above of the all-terrain vehicle floats of the present invention as adapted to pontoon boat arrangement.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

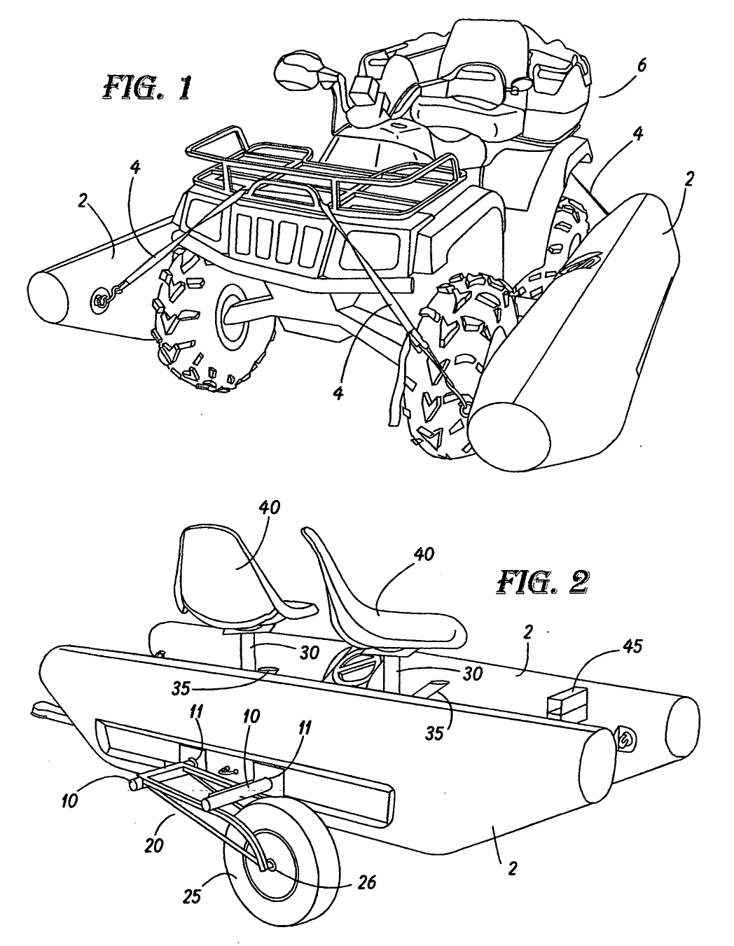

Turning to the drawings, in particular, FIG. 1, illustrating a front perspective view of the ATV floats as adapted to an ATV in a float arrangement wherein, a pair of pontoons 2 attached to a common frame work, which said framework and pontoons 2 are also attached to an ATV 6 by means of tensile straps 4 wrapped over a structural member at the front and rear of an ATV 6.

Turning to FIG. 2, which illustrates a rear perspective view of the ATV floatation device in a trailer arrangement wherein cross tubes 10 of a fixed length protrude a pair of watertight tunnel 11 each traversing a pontoon 2 when said pontoons 2 are in a collapsed position. Wheel frame members 20 are fixedly and releasably secured to said cross tubes 10 wherein a pair of wheels 25 are rotationally attached to an axle member 26 of the wheel frame member 20 so as to raise the ATV floatation device above the ground surface thus allowing towing of the whole assembly. Seat mounts 30 are fixedly attached to the central region of the framework and adapted to each receive therein, a seat 41 having a downwardly protruding stem. Additionally, angled fishing rod holders 35 are also fixedly attached to the central region of the framework near the seat mounts 30. Lastly, a motor mount 45 is provided at the rear portion of the framework so as to allow the mounting of a small outboard motor.

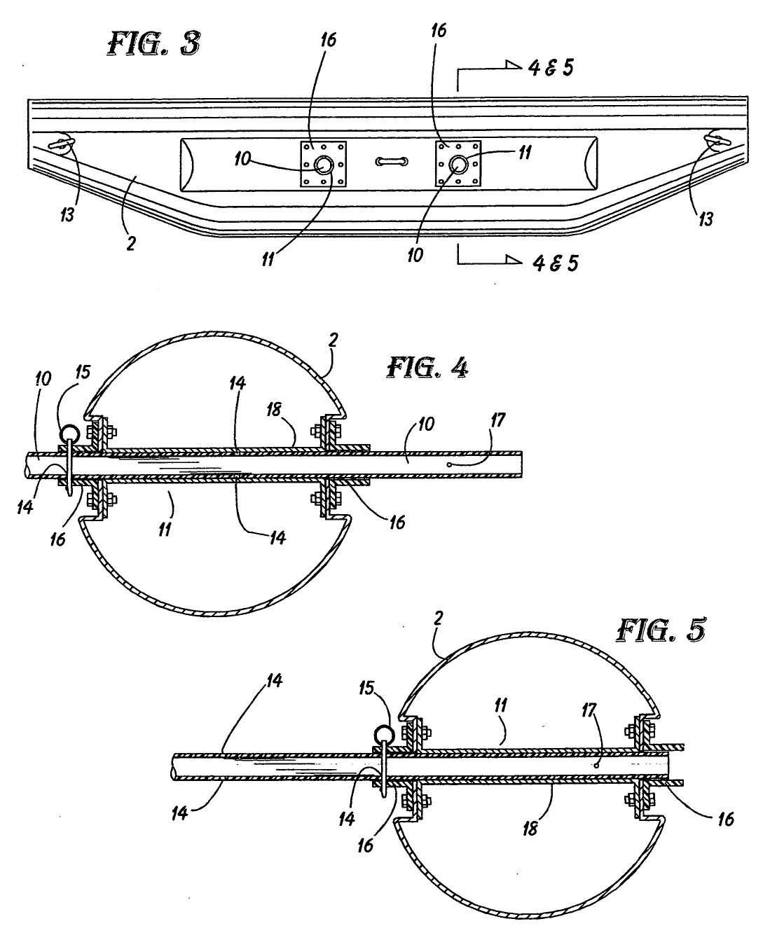

Turning now to FIG. 3, a right side elevation view of a pontoon of the ATV floatation device of the present invention illustrating the arrangement of a pair of watertight tunnels 11 traversing the hollow body of each pontoon 2. The pontoon's 2 side portion is slightly recessed to accommodate bolt-on flange plates 16, which provide the attachment means for said watertight tunnels 11. Two eyebolts 13, also slightly recessed within the pontoon's 2 side portion, are provided to allow attaching means of a tensile strap thereto.

Referring now to FIGS. 4 and 5, both cross-sectional views taken from FIG. 3 of a pontoon 2 of the present invention wherein it can be seen that the pontoons 2 are hollow and have a flattened recessed portion at both sides to better fit flanged tubular inserts thus forming a tunnel 11 through said pontoon 2. An inner flanged tube 18 has a total length, including both end flanges, equal to that of the inner dimension between said flattened recessed side portions. Two outer equally flanged plates 16 have a central opening generally equal to the opening within the inner flanged tubes 18. The pontoons 2 are bored to have an opening in alignment with both the inner flanged tube 18 and the outer flanged plates 16. Additionally, the pontoons 2, the inner flanged tube 18 and the outer flanged plates 16 have a plurality of perforations around the central openings of same to accept an equal number of fasteners therethrough in order to tightly assemble the pontoons 2, the inner flanged tube 18 and the outer flanged plates 16 together so as to form a watertight seal between the pontoon's 2 inner body volume and ambient air.

Again from FIGS. 4 & 5, it can be seen how a cross member 10 traverses the tunnel formed by the above assembly. Said cross member 10, has an outside diameter only slightly lesser than that of the tunnel's inner diameter so as to enable longitudinal motion between the cross member 10 and the tunnel.

In FIG. 4, the illustration depicts the arrangement of the above in a state where the pontoons 2 would be in a collapsed position such as when in a trailer arrangement. The cross member 10 protrudes outwardly thus enabling sufficient material to releasably attach a later mentioned wheel frame member. A bore 17 is provided through and near each end of the cross member 10 so as to allow fastening the wheel frame member to said cross member 10. Longitudinal motion between the cross member 10 and the tunnel 11 is thereby disabled when a cotter pin 15 is inserted through both a bore 14 in the cross member 10 and the outer flange plate 16 proximal to the center of the floatation device.

In FIG. 5, similar to FIG. 4 but the pontoon 2 is displaced along cross member 10 thereby separating both pontoons 2 so as to widen the stance as a whole. Two sets of perforations 14 are bored through the cross member 10 to allow the insertion of the cotter pin 15 therethrough and through the outer flange plate 16 proximal to the center of the floatation device. Therefore, the extremities of the cross members 10 are concealed within the tunnel 11 and a seal between the pontoon's 2 inner body volume and ambient air is maintained.

Referring now to FIG. 6, a partial right side elevation view of the ATV floatation device of the present invention in a trailer arrangement wherein, a wheel frame member 20 is depicted having a rear seat 50, a front seat 51, a curved strut 52, a support strut 53, and an axle flange 54. The assembly comprises two sets of a curved strut 52, a support strut 53, and an axle flange 54 both of which are fixedly and perpendicularly attached to each end portion of both the rear seat 50, and the front seat 51. A wheel axle traverses the axle flange 54 and a wheel 25. The assembly thereby mounts quickly to the cross members 10 by first placing the front seat 51 over the front cross member then placing the rear seat 50 under the rear cross member. The wheel 25 center, being behind the rear cross member 10 thereby exerts upward force behind the rear cross member thus the front seat 51 exerting a downward force onto the front cross member. Cotter pins again retain this positioning securedly yet releasably.

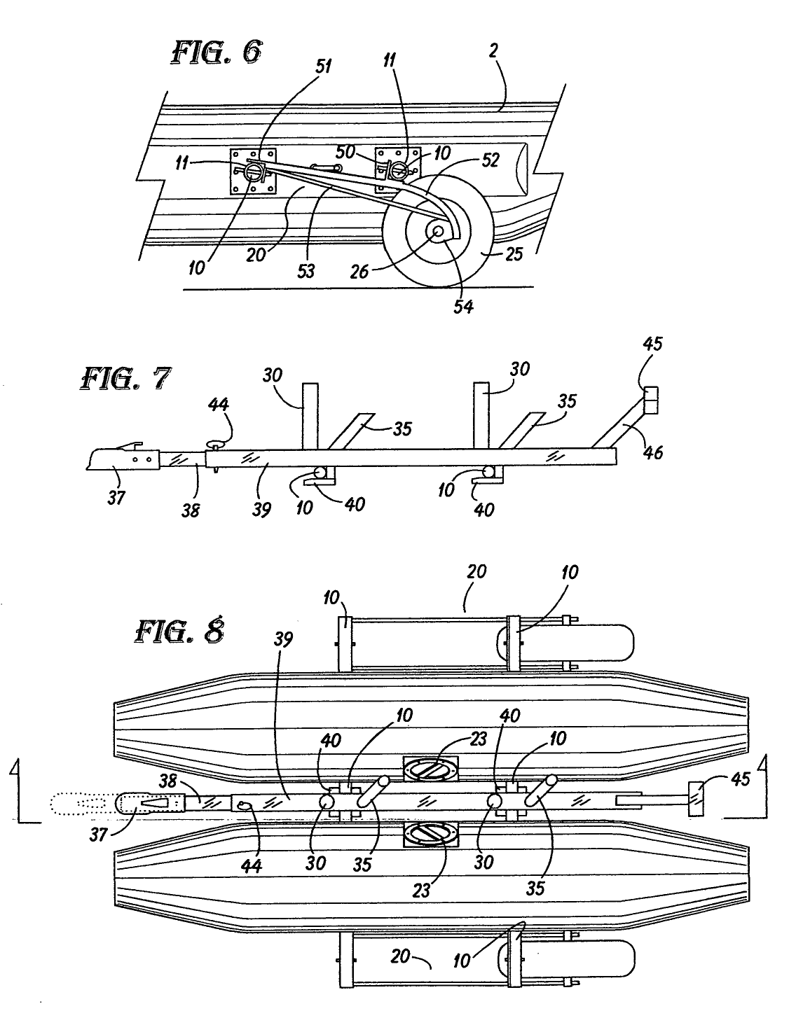

Referring now to FIG. 7, illustrating a sectional view taken from FIG. 8 of the framework to which all components rely on. The tongue generally comprises an inner tube 38 and an outer tube 39 slidably engaged to each other, the inner tube 38 adapted with a hitch adapter 37. A cotter pin 44 provides a locking member to disable said sliding motion.

A motor mount 45 having an extension member 46 is fixedly attached to the top-rear portion of the outer tube 39. Seat mounts 30 and fishing rod holders 35 are also fixedly attached to the top central portion of the outer tube 39.

Cross members 10 are secured to the framework by frictionally engaging within a pair of bar retainers 40 wherein the framework rests atop the cross member 10, and the bar retainers 40 fixedly attached to the lower surface of the outer tube 39 and spaced equally to the space between the cross members 10 thereby preventing the framework and cross members 10 from separating.

Turning to FIG. 8, a top plan view of the ATV floatation device of the present invention in a trailer arrangement wherein the arrangement can be better seen illustrating the pontoons 2 closer together, and the cross members 10 extending outwardly from said pontoons 2 thus providing attaching means of the wheel frame members 20. It can also be seen that the framework having seat mounts 30, fishing rod holders 35 and a motor mount 45 fit comfortably in a narrow space between the pontoons 2. The tongue is shown recessed into the outer tube 39 and held in place with a cotter pin 44. In a trailer arrangement, one would simply remove said cotter pin 44, pull out the inner tube 38 until a secondary bore in the inner tube 38 aligns with the bore of the outer tube 39, and re-insert the cotter pin 44 through the tube assembly. Pontoon access ports 23 are provided in each pontoon 2. these ports 23 serve two major functions; one, to give access to the inside of the pontoons 2 for assembly of the through-tunnels, and two, as a storage compartment wherein a ringed bag is inserted at the opening, which is then covered with a lid.

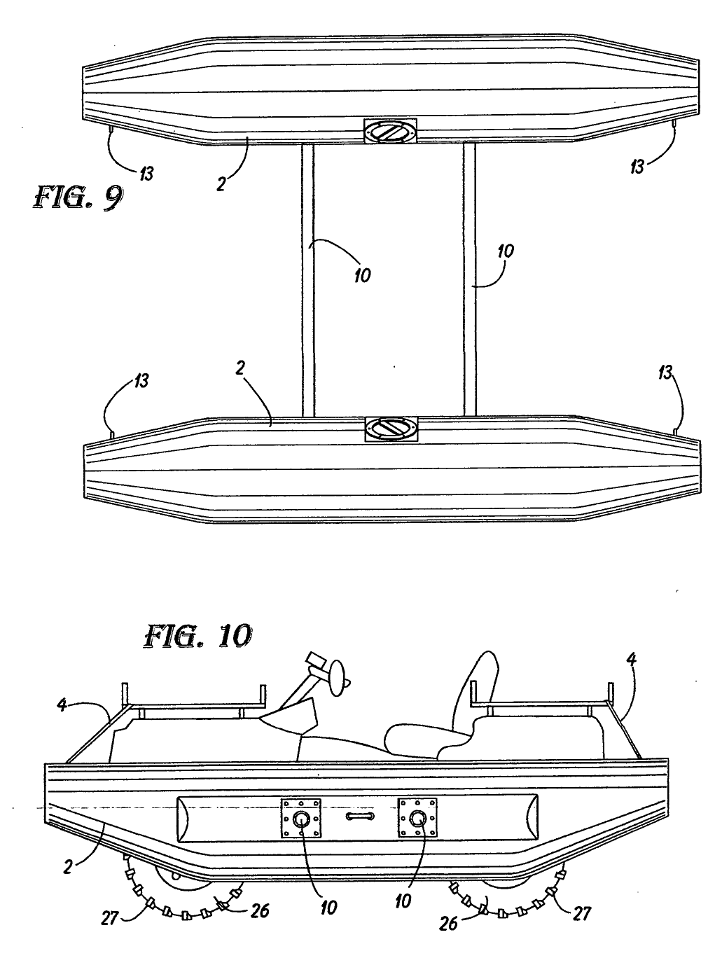

Referring now to FIG. 9 illustrating a top plan view of the ATV floatation device of the present invention in a float arrangement wherein when the pontoons 2 are separated as shown, one can simply drive the ATV between the pontoons 2 and over the cross members 10 until the cross members 10 are generally centrally placed under the ATV. Now the pontoons are ready to be lifted and strapped to the ATV using the eyebolts 13 provided at each inner end of the pontoons 2. As the cross members 10 connect with the ATV's belly area, and the tensile straps are tightened, the floats are then secured firmly with the ATV.

Turning now to FIG. 10, one can see that once the pontoons are mounted as described in FIG. 9 using the tensile straps 4, the ATV wheels 26 protrude downwardly below the pontoons 2. This allows the user to ride the ATV on both the ground and water bodies. Furthermore, on water, the treads 27 of the ATV wheels 26 serve as a propulsion system for the floating ATV. Accordingly, one can also mount a small outboard motor to the ATV's rear cargo rack for added propulsion.

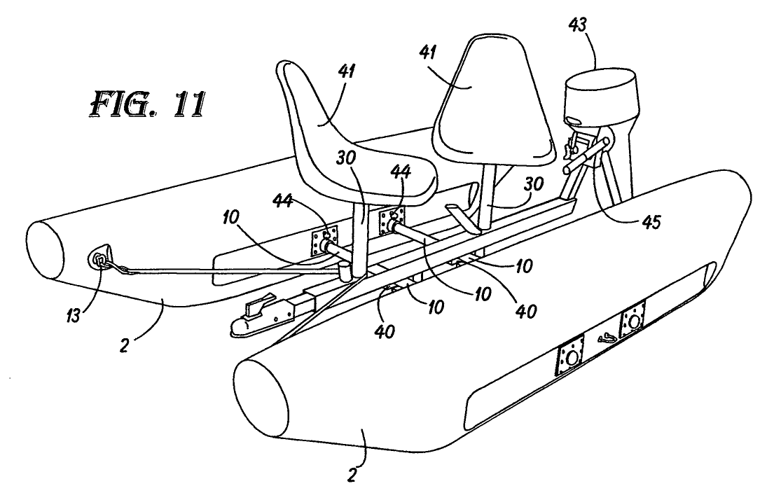

Finally, in referring to FIG. 11, a front perspective view from above of the all-terrain vehicle float device of the present invention in a pontoon boat arrangement wherein, the pontoons 2, slidably engaged with cross members 10 are spaced apart to the extent of the cross members 10 and fixed in place with a cotter pin 44 at each extremity of both cross members 10. Said cross members 10 are frictionally engaged with bar retainers 40 further depicted in FIG. 7, thus preventing the separation of the framework and the cross members 10. A tensile strap 4, secured to the front inner eyebolts on the pontoons 2 is wrapped around the first seat stem 30 so as to ensure the cross members 10 do not disengage front the bar retainers 40.

Therefore, the pontoon structure fitted with seats 41 in the seat stems 30, and a small outboard motor 43 onto the motor mount 45, along with other features of the present invention, can provide a very useful, and versatile watercraft for the user.

1. An all-terrain vehicle float device generally comprising:
a. at least two pontoons,
b. a framework,
c. cross members, and
c. two removable wheel assemblies,

2. The all-terrain vehicle float device of claim 1, wherein each pontoon comprises: a hollow elongated body having a flattened recessed portion at both sides to better fit flanged tubular inserts through said pontoon, an inner flanged tube having a total length, including both end flanges, equal to that of the inner dimension between said flattened recessed side portions, two outer equally flanged plates having a central opening generally equal to the opening within the inner flanged tubes, two or more bores at an opening in alignment with both the inner flanged tubes and the outer flanged plates, the pontoons and the inner and outer flanged plates having a plurality of perforations around the central openings of same to accept an equal number of fasteners therethrough so as to tightly assemble the pontoons, inner flanged tube and outer flanged plates together so as to form a watertight seal between the pontoon's inner body volume and ambient air,

3. The all-terrain vehicle float device of claim 1 wherein the framework comprises: a tongue having an inner tube and an outer tube slidably engaged to each other wherein, the inner tube is adapted with a hitch adapter for towing with a ball hitch and two pairs of perforations therethrough, and wherein the outer tube comprises: a motor mount having an extension member fixedly attached to the top-rear portion of the outer tube, seat mounts fixedly attached to the top central portion of the outer tube in which seats with downwardly protruding stems can be rotationally engaged, fishing rod holders also fixedly attached to the top central portion of the outer tube, bar retainers fixedly attached to the lower surface of the outer tube and spaced equally to the space between the cross members thereby preventing the framework and cross members from separating, and a cotter pin to provide a locking member to disable sliding motion between the inner and outer tubes,

4. The all-terrain vehicle float device of claim 1, wherein the cross members are of equal length to each other and have an outer diameter slightly lesser than that of the inner diameter of a pontoon inner flanged tube,

5. The all-terrain vehicle float device of claims 1 or 4, wherein the cross members provide lateral motion between the pontoons so as to enable the sideward distancing of said pontoons,

6. The all-terrain vehicle float device of one of claims 1 through 5 wherein the use thereof is to provide sportsmen with a combination; pontoon boat, cargo trailer, ATV floats, and an ATV stabilizer that is unobtrusive and provides the desired freedom of all feature uses.
